(19) United States
(12) Patent Application Publication
(10) Pub. No.: US 2008/0264910 A1
(43) Pub. Date: Oct. 30, 2008

(54) Process for Fabricating Optical Waveguides

(76) Inventors: Raman Kashyap, Baie D'Urfe (CA); Vincent Treanton, Cremieu (FR)

Correspondence Address: FAY KAPLUN & MARCIN, LLP, 150 BROADWAY, SUITE 702, NEW YORK, NY, 10038, US

(21) Appl. No.: 11/575,285

(22) PCT Filed: Oct. 5, 2004
(86) PCT No.: PCT/CA2004/001798

§ 371 Date: Jun. 17, 2008

(30) Foreign Application Priority Data
Sep. 14, 2004 (CA) 2,479,986

(51) Int. Cl. B23K 26/36

(52) U.S. Cl. 219/121.61; 219/121.66; 219/121.65

(57) ABSTRACT

A one step process for fabricating planar optical waveguides comprises using a laser to cut at least two channels in a substantially planar surface of a piece of dielectric material defining a waveguide there between. The shape and size of the resulting guide can be adjusting by selecting an appropriate combination of laser beam spatial profile, of its power and of the exposure time. A combination of heating and writing lasers can also be used to fabricate waveguides in a dielectric substrate, wherein the heating laser heats the substrate with a relatively broad focused spot, the power of the heating laser being controlled to raise the temperature heating the substrate just below the substrate's threshold temperature at which it begins to absorb electro-magnetic radiation, the writing laser, which yields a spot size smaller than the heating laser then melts the substrate within the focal spot of the heating laser. Compare to processes from the prior art, a waveguide fabrication process according to the present invention results in lower cost, faster processing time and applicability to a wider range of materials. The present process is particularly suited for the mass production of inexpensive photonic devices.

### FIELD OF THE INVENTION

The present invention relates to optical waveguides. More specifically, the present invention is concerned with a process for fabricating planar optical waveguides.

### BACKGROUND OF THE INVENTION

For many years, the photonics industry has grown steadily primarily driven by the increasing demand for complex optical functionality. More recently, the need to save space and lower cost of deployment has overtaken the requirement for developing optical devices. Many new promising optical devices were proposed to create an all-optical network with novel passive and active optical devices to modify the transmitted information. Many of these failed to meet expectations on grounds of cost.

Until recently, devices were based on fibre or free-space, both of which require careful alignment and subcomponent selection; resulting in low yields and expensive products caused mainly by the remaining intensive labour. More recently, planar optical integrated circuits were introduced with the following potential advantages: possibility of manufacturing in existing microelectronics facilities, integrating sources and detectors with the devices on the same chip, minimizing alignment requirements which lead to better reproducibility. All these advantages make the technique more suitable for mass production thus potentially lowering costs. Even though there is currently considerable interest in the potential of this technology, it produces devices with moderate insertion loss due to the fabrication technique as well as in/out coupling. Another drawback of current planar optic manufacturing process is that it involves expensive facilities to perform the micro-fabrication and places considerable limitations on the types of materials that can be used for the substrates.

Current planar waveguide manufacturing processes include direct writing of the guide by an ultraviolet laser. However, this technique is limited to writing in materials which are highly photosensitive, and therefore inapplicable to most optically non-linear materials.

It has also been proposed to use a femtosecond laser that generates ultra-short pulses. Even though it allows writing into many types of materials, a drawback of such method is that, it induces modification in the material structure. This yields asymmetry and irregularities in the resulting guide, thereby increasing the losses in the cross coupling with optical fibres for example, and also a modification of the material properties in the region of interest. Moreover, this process causes damage to the material by yielding a depression at the irradiation site, which may be detrimental to subsequent layer deposition. Further, the writing speed is very slow and the index difference that can be induced is intrinsically linked to loss, and therefore limits commercial exploitation.

Finally, plasma enhanced chemical vapour deposition (PECVD) is also known in the art to fabricate waveguide. However, a drawback of this last process is that it is intensive in processing and requires a large infrastructure and many processing steps to fabricate waveguides. For example, mask-making, alignment techniques, chemical or plasma etching, and re-flow to cover waveguides are necessary for successful fabrication of the waveguides.

### OBJECTS OF THE INVENTION

An object of the present invention is therefore to provide an improved process for fabricating optical waveguides.

### SUMMARY OF THE INVENTION

A process for fabricating waveguide according to the present invention comprises etching a substrate using a laser so as to create channels on both sides of a region, which will result in a waveguide. Such a process may be used to etch most materials used to fabricate photonic devices including both amorphous and crystalline materials

More specifically, in accordance with the present invention, there is provided a process for fabricating an optical waveguide comprising:

providing a piece of material having a substantially planar surface; and

using at least one laser characterized by a wavelength and a power to cut at least two channels in the substantially planar surface of the piece of material; the dielectric material being substantially absorptive to the wavelength to cause melting of the substrate at the laser power;

whereby, the at least two channels defining a waveguide there between.

For example, a laser, such as a carbon-dioxide laser operating at a wavelength of 10.6 microns, which is focused on to the surface of a planar substrate whilst it is being translated in a linear direction orthogonal to the direction of the laser beam, causes a channel to be created by localized melting. By creating a second channel adjacent to the first with a small gap in between, allows the formation of a waveguide sandwiched in-between. This simple process may be repeated for curved, tapered, buried or other waveguides.

Alternatively, as the spot size of the 10.6 micron radiation is quite large (in the order of 10-20 microns), the carbon-dioxide laser may be used in conjunction with another shorter wavelength laser, such as a Nd:YAG laser emitting radiation at 1.06 microns, or Argon-ion laser radiation at 514 nm. The purpose of this scheme is to enable the CO₂ laser to act as a heat source to elevate the temperature of the waveguide substrate such that additional radiation from the second laser is strongly absorbed in the region of the focused CO₂ radiation. However, the resulting melt zone is now significantly smaller than the CO₂ laser spot.

Since a process for fabricating waveguide according to the present invention does not modify the material's structure or its refractive index, it is particularly suitable for writing waveguide in materials showing nonlinearities or wherein nonlinearities can be induced.

The present waveguide fabrication process can be used to create optical devices that can be easily integrated with optoelectronic devices, resulting, for example in passive and active components on a single chip, by cutting channels at the ends of waveguides to drop in other components, using the same processing laser.

The present process allows production of low loss waveguides in a variety of materials.

Compare to processes from the prior art, a waveguide fabrication process according to the present invention results in lower cost, faster processing time and applicability to a wider range of materials. The present process is particularly suited for the mass production of inexpensive photonic devices.

According to a second aspect of the present invention, there is provided a system for fabricating an optical waveguide comprising:

a support for receiving a piece of material having a substantially planar surface; and

at least one laser for producing a beam for cutting at least two channels in the substantially planar surface of the piece of material so as to define a waveguide therebetween.

According to a further aspect of the present invention, there is provided a process for fabricating an optical waveguide comprising:

providing a piece of material having a substantially planar surface;

using at least one laser characterized by a wavelength and a power to cut at least one channel in the substantially planar surface of the piece of material; the dielectric material being substantially absorptive to the wavelength to cause melting of the substrate at the laser power; and

filling the at least one channel with a high refractive index material;

whereby, the at least one channel defining a waveguide.

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

In the appended drawings:

FIG. 1 is a schematic view illustrating a planar optical waveguide fabrication process according to a first illustrative embodiment of the present invention;

FIGS. 2 and 3 are micrographs of first and second planar optical waveguides fabricated using the process illustrated in FIG. 1;

FIG. 4 is an enlarged view of one of the channels of the waveguide illustrated in FIG. 3;

FIG. 5 is a schematic perspective view illustrating the interaction between the laser beam and the substrate in the process illustrated in FIG. 1;

FIG. 6 is a schematic section of a channel obtained by the process illustrated in FIG. 1, illustrating the characterizing parameters of such a channel;

FIG. 7 is a schematic view illustrating an optical assembly used to characterize the interaction between a CO₂ laser beam and a silica substrate in the process illustrated in FIG. 1, the assembly including a system for fabricating a waveguide according to a first illustrative embodiment of the present invention;

FIG. 8 is a graph illustrating the relationship between the waist of the laser and the position along the focalizing direction using lens and a translation stage to examine the beam dimensions;

FIGS. 9 to 13 are micrographs of channels obtained using the assembly from FIG. 7, with five different combinations of laser power and etching speed;

FIGS. 14a and 14b are graphs illustrating the relationship between respectively the width and the depth of channels from FIGS. 9 to 13 and the etching speed;

FIGS. 15a and 15b are graphs illustrating the relationship between respectively the width and the depth of channels from FIGS. 9 to 13 and the number of runs;

FIG. 16 is a schematic perspective view illustrating a planar optical waveguide fabrication system and process according to a second illustrative embodiment of the present invention;

FIGS. 17a-17b are respectively schematic side elevation and top plan views respectively illustrating ridge and buried waveguides exemplifying waveguides that can be obtained through the system and process illustrated in FIG. 16;

FIG. 18 is a schematic view illustrating a one-to-four splitter obtained using the system and process illustrated in FIG. 16; and

FIG. 19 is a schematic view illustrating an Arrayed-Waveguide Grating (AWG), exemplifying an application of the system and process from FIG. 16.

### DETAILED DESCRIPTION

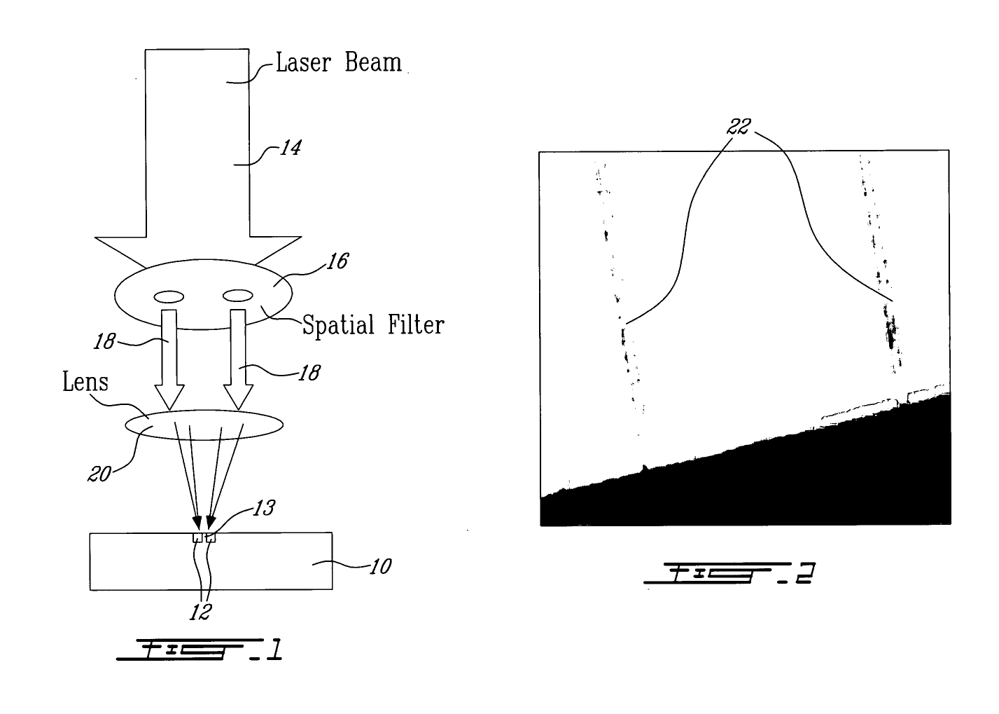

A process and system for fabricating planar waveguides according to a first illustrated embodiment of the present invention will now be described with reference to FIG. 1.

A high power laser, for example of the CO₂ type (not shown), is used to cut into a substrate material in our current embodiment in the form of a glass plate 10, two substantially parallel channels 12, defining a ridge waveguide 13 there between.

It is to be noted that the substrate material may be a metal, a semiconductor or a dielectric.

More specifically, the CO₂ laser produces a beam 14 of a 10.6 micron wavelength which is split through a spatial filter 16 producing two parallel beams 18 that are focused through a lens 20 onto the surface of the substrate 10. It is believed to be within the reach of a person skilled in the art to adequately select the spatial filter 16 and lens 20 so as to yield a desired distance between the two channels 12. Of course the dimensions of the two channels 12 have been greatly exaggerated on FIG. 1 to better illustrate the process.

The substrate 10 is mounted on a movable table (not shown) allowing translating the substrate 10 during the laser cutting process. Of course, the laser may alternatively be movably mounted over the substrate 10, which is then immobilized.

The two laser beams 18 may, of course, be produced by two different lasers (not shown).

The use of a high power laser allows melting of the glass plate 10. The laser is chosen accordingly to the nature of the substrate 10 so that the luminous energy of the laser is absorbed thereby so as to cause melting of the substrate 10.

As will be described herein below in more detail, desired depth and width of the channels 12 are obtained by controlling the spatial characteristics and the writing or etching speed of the laser, i.e. the translation speed of the engraving laser relatively to the substrate 10.

A thin film of any size can also be used as a substrate.

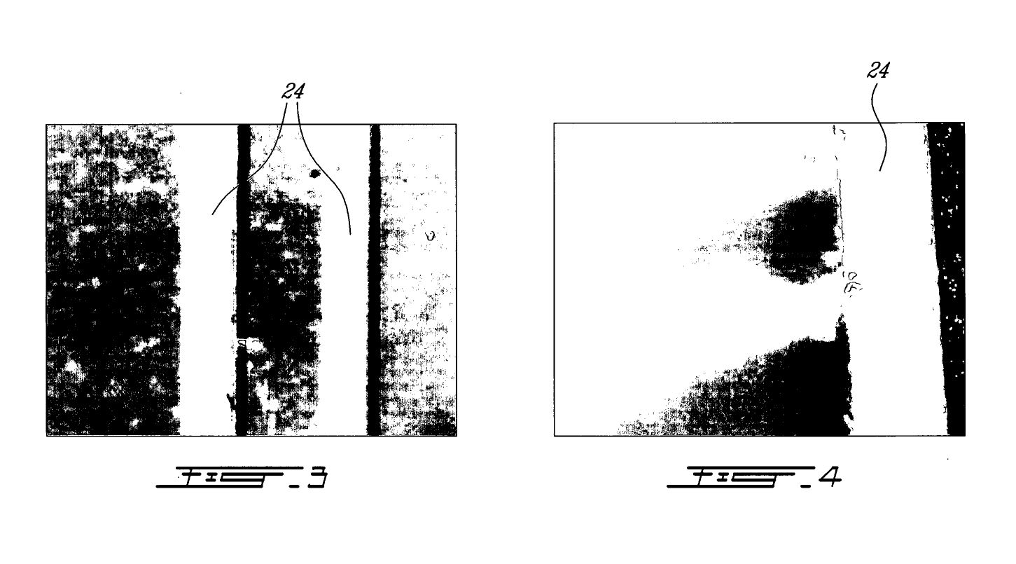

FIGS. 2 and 3 are micrographs illustrating first and second waveguides each comprised of two parallel channels 22 and 24 respectively obtained in silica using the process illustrated in FIG. 1. For example, the channels 24 have been obtained using a CO₂ laser having a 30 microns spot size, which resulted in a channel width in the order of 5 microns.

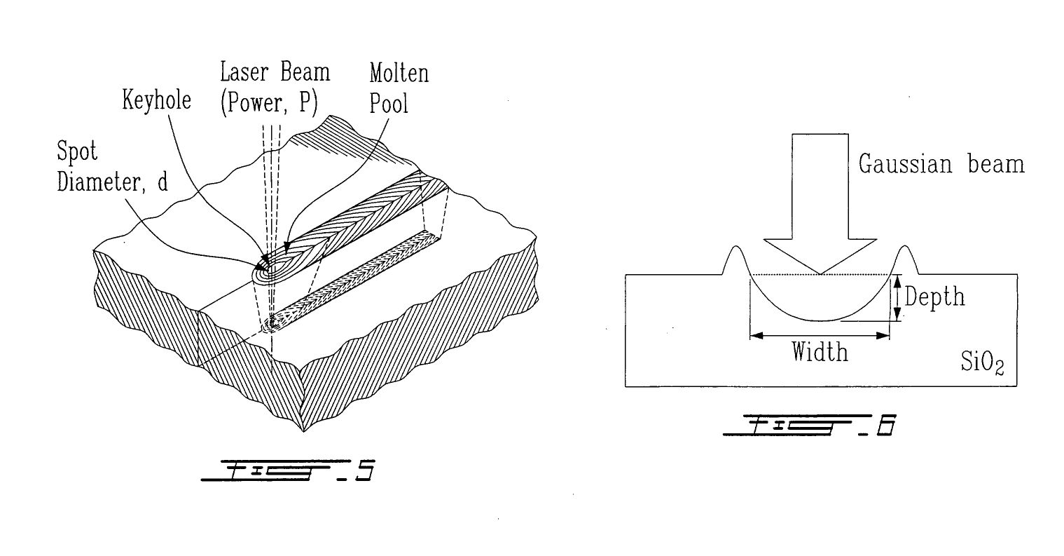

FIG. 4 is an enlarged view of one of the two channels 24 from FIG. 3. As can be seen from this figure, the walls of the channels 24 are smooth which contributes to minimize the propagation loss in the guide. The smoothness of the channels' wall results from the fact that the laser has heated the substrate during etching.

Experimental results shown that waveguides of only 6 μm realized in silicon dioxide thin films using the process illustrated in FIG. 1 were able to guide lights while no scattering was observed, which is also indicative that the edge of the channels forming the waveguide are smooth.

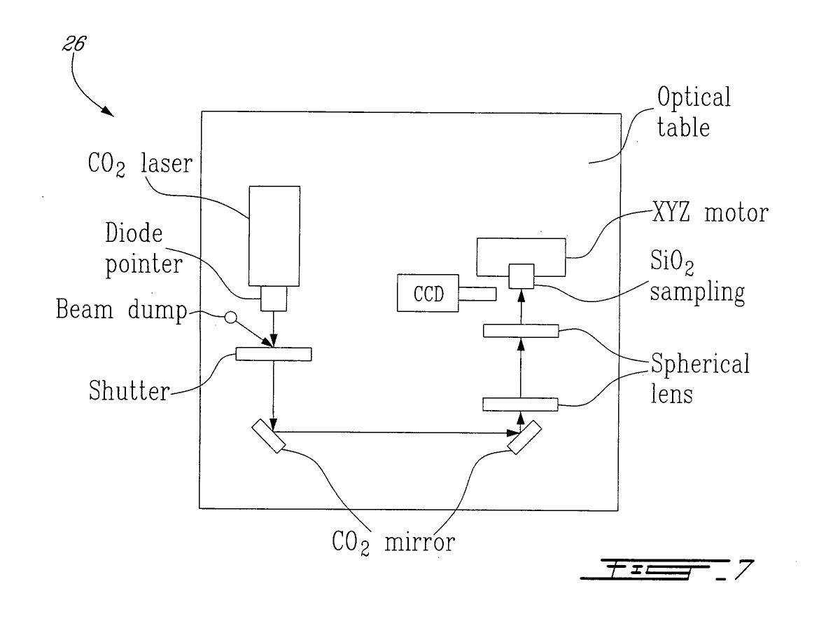

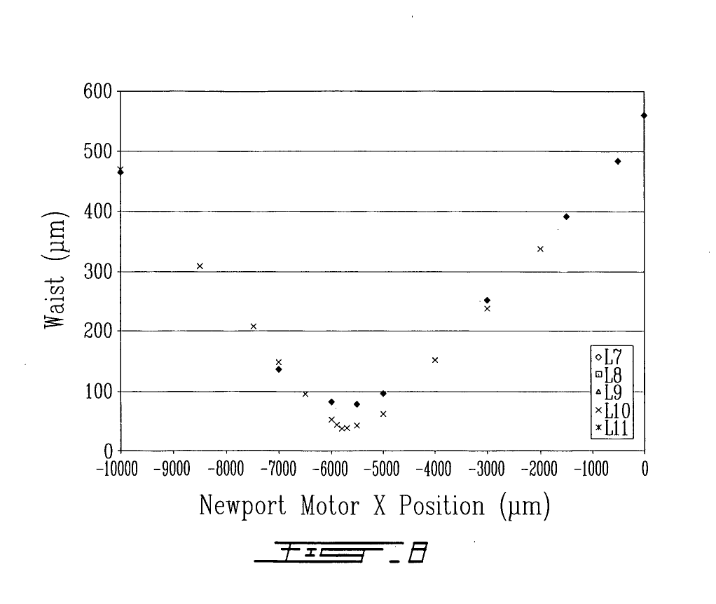

Further experiments have been conducted using a CO₂ laser to characterize the interaction of the laser on different dielectric materials, and more precisely the impact of the power of the laser, of its spot size, and of the translation speed of the material to etch relatively to the laser (see FIG. 5) on the depth and width of the resulting channel (see FIG. 6). The optical assembly 26 that has been used in such experimentation is illustrated in FIG. 7.

Through the experiments, five (5) samples L7 to L11, which shown uniform etching along the channel, were quantified. As can be seen in the following Table, each of the five samples has been etched using a different laser power.

| Sample | Power (mW) | Spot (mm) |
|---|---|---|
| L7 | 820 | 80 ± 2 |
| L8 | 1040 | |
| L9 | 1230 | |
| L10 | 1430 | |
| L11 | 1630 | |

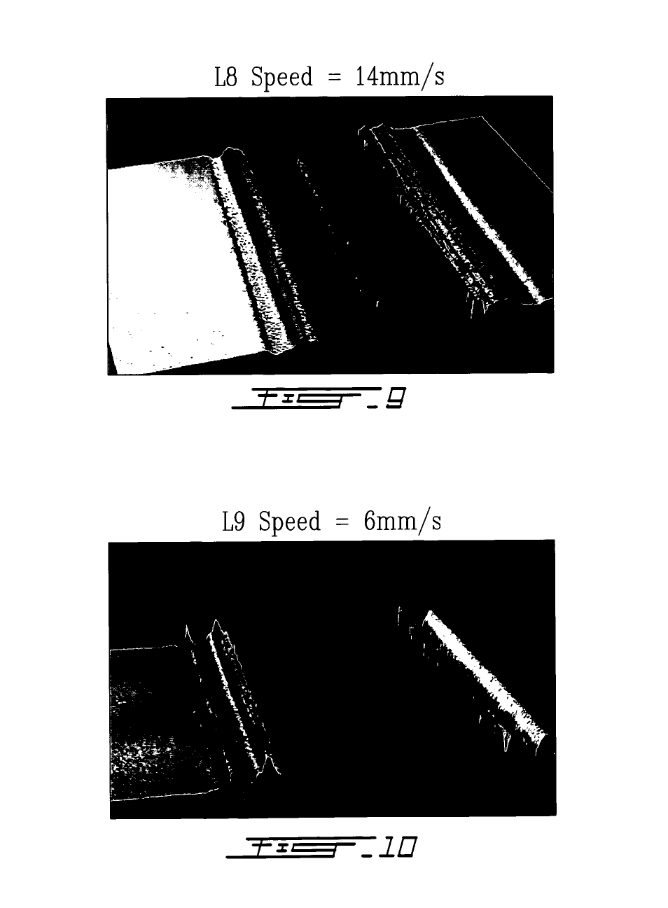

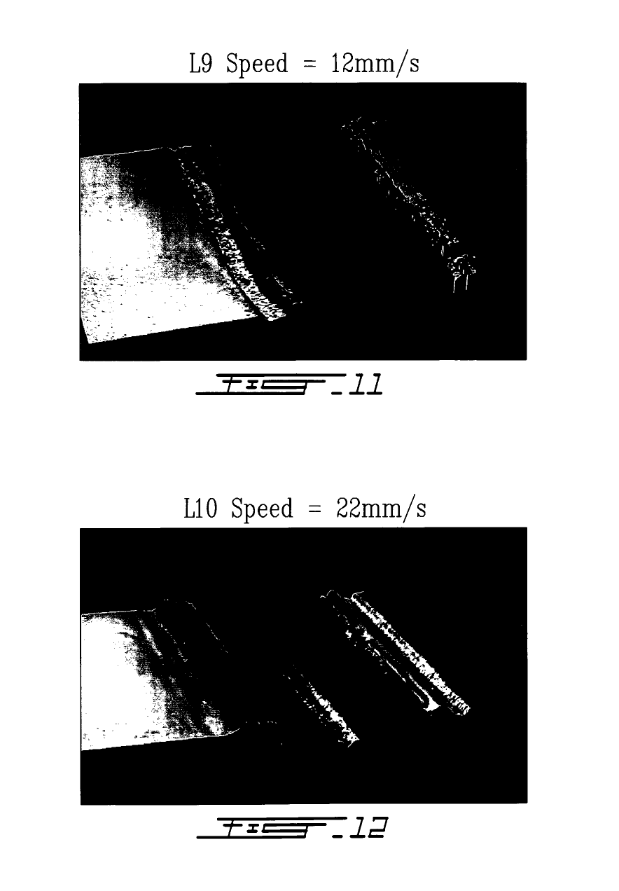

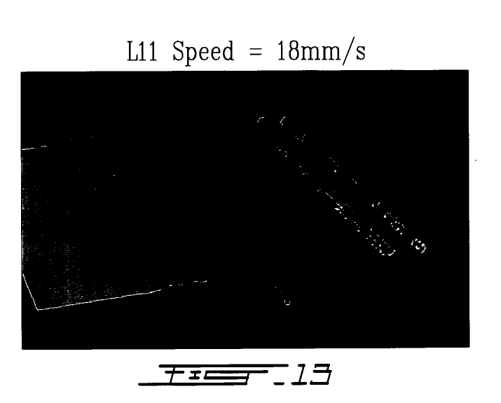

More precisely, a Veeco NT 100 optical profiler has been used to characterize the channels of each sample adapted for a 600±10 mW power and a spot size of 110±10 μm. FIGS. 9 to 13 have been obtained for a translation speed of 14 mm/s, 6 mm/s, 12 mm/s, 22 mm/s and 18 mm/s respectively.

FIG. 8 shows the waist of the laser beam in front of the spherical lens (see FIG. 7). As can be seen, the minimum waist may be controlled to around 40 microns using the current optics. This also indicates the difficulty of obtaining high quality diffraction limited optics at 10.6 microns.

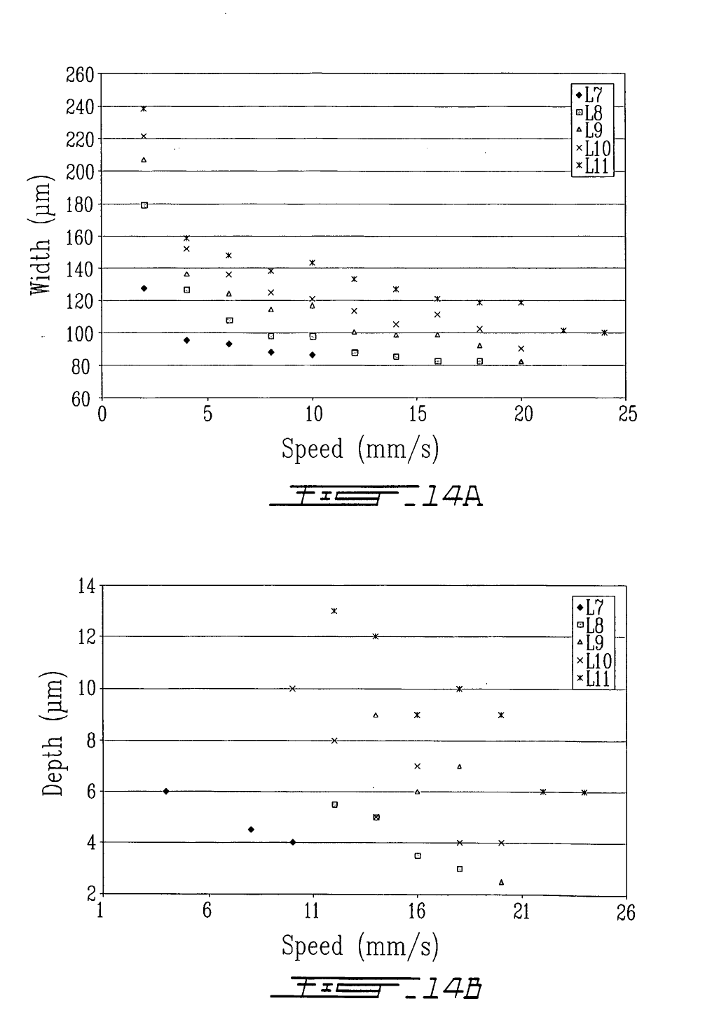

FIG. 14a illustrates the relationship between the etching speed and the width of the resulting channel.

FIG. 14b illustrates the relationship between the etching speed and the depth of the resulting channel.

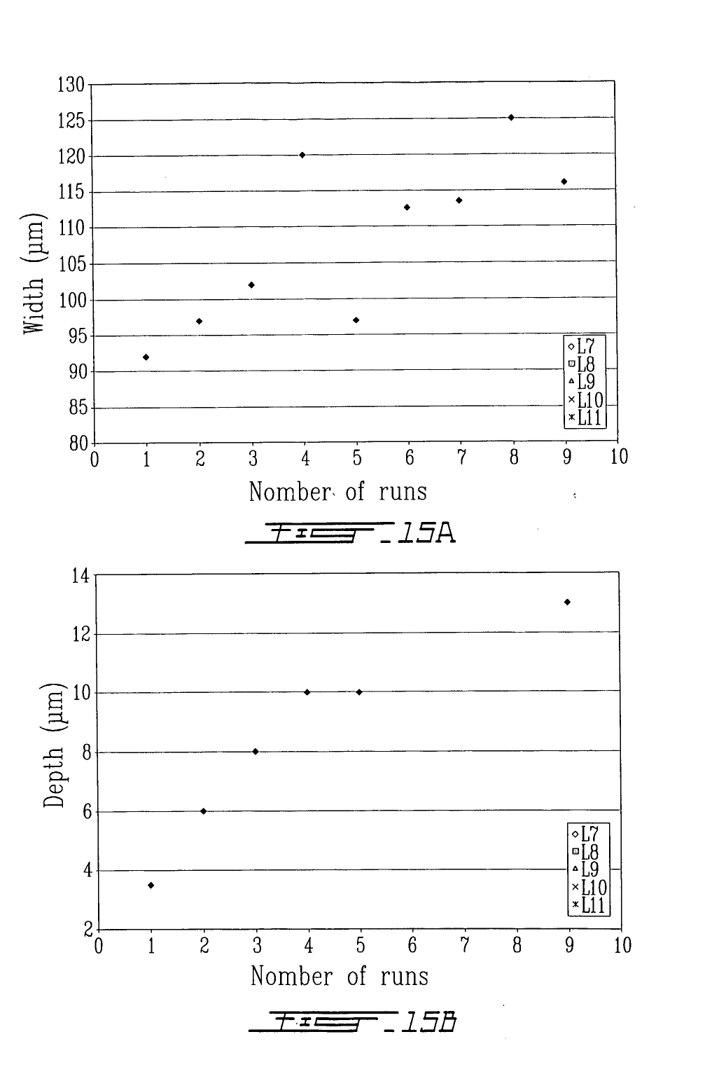

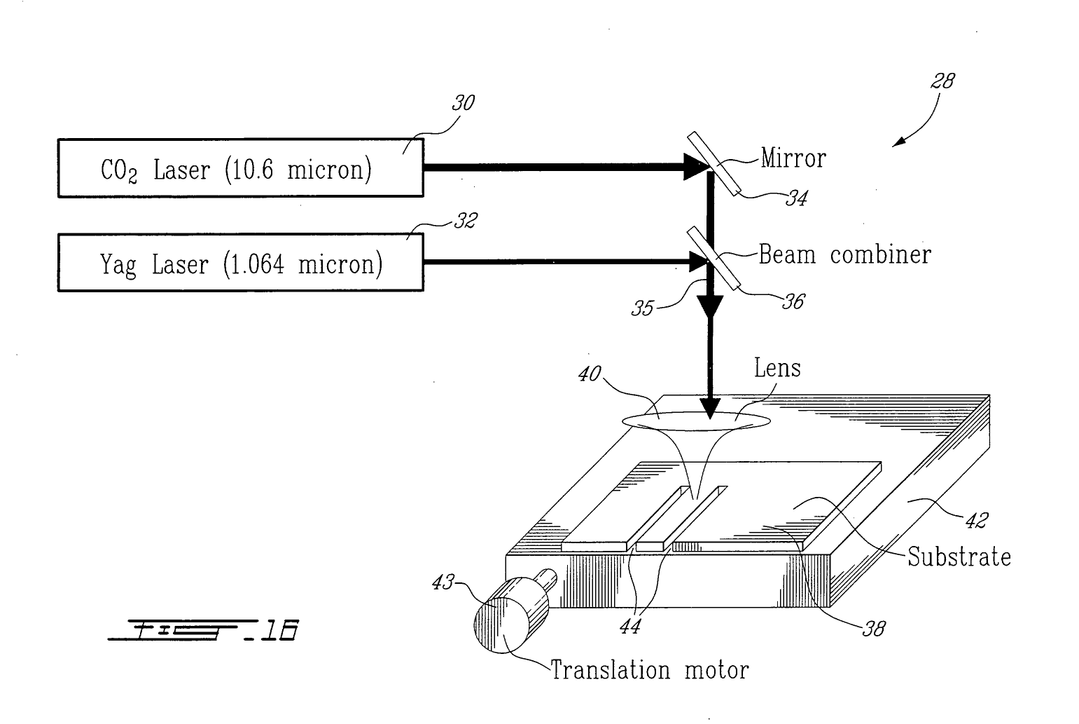

FIGS. 15a and 15b illustrates the relationship between the numbers of run, i.e. the number of passage of the laser over the substrate, respectively relatively on the width and on the depth of the resulting channel, providing a 1040 mW power and a translation speed of 16 mm/s.

These experiments allow characterizing the etching effect of the laser on the substrate. They show that the shape and size of the resulting guide can be adjusted by selecting an appropriate combination, for example, of laser beam spatial profile, of its power and of the exposure time.

A CO₂ laser as used in the systems described with reference to FIGS. 1 and 7 provides a focused spot having a diameter of about 20-30 microns. To obtain a spot size in the order of the micron, a Nd: YAG laser, which has a wavelength of 1.06 microns, can be used. However, since silica, for example, is normally transparent to that wavelength, a channel would be difficult to cut therein unless a pulsed very high intensity source, for example in the order of gigawatts/cm² is used.

Transparent dielectrics, such as optical fibres and other glasses are useful for transmitting optical signals over long lengths owing to their transparency. Normally, these devices can carry watts of near-infrared optical radiation as has been shown by Kashyap in [1]. Moreover, these fibres can be used to deliver tens of watts of 1 to 1.5 micron wavelength radiation without damage, for medical and telecommunications applications, and have been successfully deployed commercially. However, if the dielectric is heated above a critical temperature, for example, by an outside source, it has been found [2] that the dielectric becomes highly absorptive at wavelengths at which they are normally transparent.

Turning now to FIG. 16, a process for the fabrication of waveguides according to a second illustrative embodiment of the present invention and a system 28 therefore will be described. These process and system make use of the above-described property of heated dielectrics.

The system 28 comprises a heating laser 30, in the form of a CO₂ laser having a 10.6 microns wavelength and yielding a spot size of about 30 microns, a writing laser 32, in the form of a Nd:YAG laser having a 1.064 micron wavelength and yielding a spot size of about 1 micron, a mirror 34 for aligning one of the heating and writing laser beam with the other, a beam combiner 36 for combining the heating and writing laser beams and for aiming the combined beam 35 towards a silica substrate 38, a lens 40 for focusing the combined beam 34 onto the substrate 38, a support 42 for fixedly receiving the substrate, and a translation motor 43 for translating the substrate 38 relatively to the combined beam 34.

Of course, the mirror 34 may receive the heating laser beam for alignment with the writing laser beam or the opposite. Also, the heating and writing lasers 30-32 may be so positioned relatively to the beam combiner 36 inputs that no such aligning mirror 34 is required.

As discussed with reference to FIG. 1, the system may be modified so that the heating and writing lasers ensemble is made movable while the substrate 38 is immobilized so as to still allow for the relative translation of the two lasers 30-32 with the substrate 38.

Of course, as described with reference to FIG. 1, a beam splitter can be used to split the combined beam 34 for cutting the two channels 44 simultaneously. Two pairs of heating-writing lasers 30-32 can also alternatively be used to simultaneously cut the two channels 44.

In operation, the CO₂ laser 30 heats the substrate 38 with a focused spot of around 20 microns in diameter. The power of the heating laser 30 is controlled to raise the temperature of the substrate 38 to about 1050° C. At this temperature, for example, silica begins to absorb very strongly the 1.06 micron wavelength of the writing laser 32. The smaller focused spot of the writing laser 32 then melts the silica within the focal spot of the CO₂ laser 30.

By scanning the two laser spots together across the substrate 38, features that are more than an order of magnitude smaller than the CO₂ laser 30 wavelength can be cut into the substrate 38. Similar to the process described with reference to FIG. 1, a waveguide can be delineated in between two such channels 44 in close proximity.

The simultaneous exposure with both laser beams pushes the total amount of energy absorbed just above the threshold of melting in a smaller localised region of the order of 1 micron.

Using a pulsed writing laser (not shown), interesting features can be incorporated. For example, through nonlinear absorption, much smaller waveguide dimensions may be inscribed. Moreover, one can transition from a waveguide region to a bulk region and then back to a waveguide region, using a controlled pulsing of the second laser. A process according to the present invention allows cutting channels to introduce fluids precisely in line with a previously formed waveguide, so that one may better utilise the complex processing capability allowed by the present invention.

The heating laser 30 and the writing laser 32 can take other forms than that of a CO₂ laser and the Nd: YAG laser respectively. Any laser having a wavelength suitable for heating the substrate just below the substrate's melting threshold can be used as a heating laser, while any laser whose wavelength is strongly absorbed by the substrate material above this threshold temperature can be used in combination with this heating laser as a writing laser.

Examples of lasers suitable for writing include Argon, Nd: YLF, Yb dobed fibre laser, or other semiconductor laser emitting a watt or more of optical radiation. The writing laser is selected to suit the desired dimensions of the feature to be written in the substrate.

The writing laser and heating laser can both either be a continuous-wave (CW) or a pulsed laser.

According to a third illustrative embodiment of a process for fabricating waveguide according to the present invention, a channel provided using one of the above-described processes is filled with a high refractive index material, the channel then becoming the waveguide.

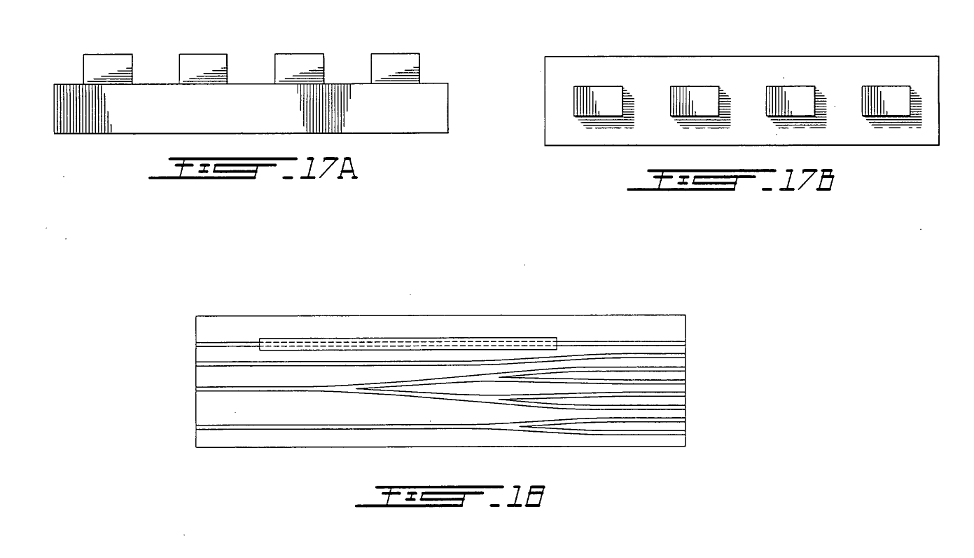

Two types of waveguides that can be fabricated using a process according to the present invention are schematically illustrated in FIGS. 17a-17b, showing respectively a ridge waveguide and a buried waveguide formed by a process according to the present invention. More specifically, the ridge waveguides illustrated in FIG. 17A are simply processed as shown in FIG. 1, whilst the buried waveguides illustrated in FIG. 17B may be formed by etching a three layers of a sandwich of a high refractive index surrounded by the lower refractive index substrate and lower refractive index overlay. Cutting through the three layers, results in a buried waveguide. The latter has the advantage of completely encapsulating the guide on the top.

A process for fabricating waveguides according to the present invention, as illustrated, for example, in FIGS. 1 and 16, can be used to write waveguide in many dielectric materials, including glass, silicon, crystalline materials, such as LiNbO₃, KTP (Potassium Titanyl Phosphate), KbNO₃, KDP, ADP, Calcite, Mica, BBO (β-Barium Borate), LBO, ferro-electric, piezo-electric or pyro-electric crystal. Other materials, such as polymers and semiconductors can also be modified using a process according to the present invention.

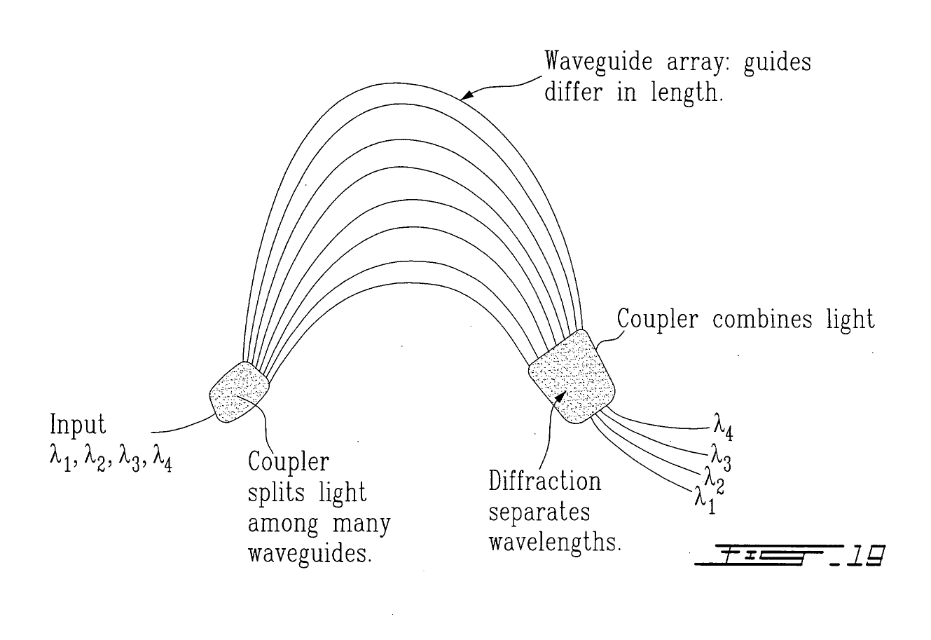

The present waveguide fabrication process can be used to create optical devices that can be easily integrated with optoelectronic devices, resulting, for example, in passive and active components on a single chip. An example of such a device, in the form of a one-to-four splitter is illustrated in FIG. 18. In this device, several waveguides converge and merge to form a coupling region, in which the energy from one of the waveguides can couple to the others, splitting the energy between the four waveguides. Such a device can be fabricated by the embodiment of our present invention by the use of the two beam writing process, allowing one beam to be turned off in the merging region.

A process for fabricating waveguides according to the present invention can be used to directly write waveguides in nonlinear and periodically poled crystals.

It is believed to be within the reach of a person skilled in the art to use the present teaching to fabricate complex optical circuits, such as the Arrayed-Waveguide Grating (AWG) schematically illustrated in FIG. 19, Mach-Zehnder interferometers (not shown), nonlinear devices (not shown) and micro-combining waveguides with chemical sensors (not shown).

Finally, a process according to the present invention allows creating active optical components whose function can be dynamically modified. For example, a periodically poled waveguide may be modified by simply post-processing to alter the guide dimensions, to allow the tuning of the phase-matching condition.

Although the present invention has been described hereinabove by way of preferred embodiments thereof, it can be modified without departing from the spirit and nature of the subject invention, as defined in the appended claims.

### REFERENCES

1. Kashyap R. and Blow K. J. “Observation of catastrophic self-propelled self-focusing in optical fibres”. Electron. Lett. 29 (1), 7 Jan. 1988, pp. 47-49.
2. Kashyap R., Sayles A. and Cornwell G. F. “Heatflow modeling and visualisation of catastrophic self-propelled damage in single mode optical fibres”. Special Mini-Symposium at the Optical Fibres Measurement Symposium, Boulder, October 1996, SPIE Vol. 2966, pp. 586-591.

What is claimed is:

1. A process for fabricating an optical waveguide comprising:
providing a piece of material having a substantially planar surface; and
using at least one laser characterized by a wavelength and a power to cut at least two channels in said substantially planar surface of said piece of material; said dielectric material being substantially absorptive to said wavelength to cause melting of said substrate at said laser power;
whereby, said at least two channels defining a waveguide there between.

2. A process as recited in claim 1 for fabricating a planar optical waveguide.

3. A process as recited in claim 1, further comprising controlling at least one of the spatial characteristic, the power or the exposure time of said at least one laser so as to control the depth or the width of said at least two channels.

4. A process as recited in claim 1, wherein said at least one laser producing a beam which is split, yielding two cutting beams for simultaneously cutting said at least two channels in said substantially planar surface of said piece of material.

5. A process as recited in claim 1, wherein said at least one laser is a CO₂.

6. A process as recited in claim 1, wherein said at least one laser includes two lasers.

7. A process as recited in claim 6, wherein using at least one laser characterized by a wavelength and a power to cut at least two channels in said substantially planar surface of said piece of material includes using a first of said two lasers heating said substrate at a heating temperature below and near the melting point of said substrate, and the second of said two lasers simultaneously writing said at least two channels using a writing wavelength absorptive by said substrate at said heating temperature.

8. A process as recited in claim 7, wherein said second laser is from a laser type selected from a group consisting of argon, Nd: YLF, Yb-doped fibre laser, and semiconductor laser.

9. A process as recited in claim 7, wherein said first laser is a CO₂ laser and said second laser is a Nd: YAG laser.

10. A process as recited in claim 1, wherein said material is a dielectric.

11. A process as recited in claim 10, wherein said dielectric is an amorphous material or a crystalline material.

12. A process as recited in claim 11, wherein said amorphous material is selected from the group consisting of glass, silica, and silicon dioxide.

13. A process as recited in claim 11, wherein said crystalline material is selected from the group consisting of LiNbO₃, KTP (Potassium Titanyl Phosphate), KbNO₃, KDP, ADP, Calcite, Mica, BBO (β-Barium Borate), LBO, ferro-electric, piezo-electric or pyro-electric crystal.

14. A process as recited in claim 11, wherein said crystalline material is a nonlinear crystal or a periodically poled crystal.

15. A process as recited in claim 1, wherein said material is a polymer or a semi-conductor.

16. A process as recited in claim 15, wherein said polymer is a periodically poled polymer.

17. A process as recited in claim 1, wherein said piece of material is in the form of a plate or of a thin film.

18. A process as recited in claim 1, further comprising translating said piece of material relatively to said at least one laser during its cutting by said laser.

19. A process as recited in claim 1, wherein said channels define walls which are smooth.

20. A process as recited in claim 1 for fabricating a ridge waveguide, a channel waveguide or a buried waveguide.

21. A process as recited in claim 1 for fabricating an optical circuit.

22. A process as recited in claim 21, wherein said optical circuit is selected from the group consisting of an arrayed-waveguide grating, a Mach-Zehnder interferometer, a micro-combining waveguide and a nonlinear device.

23. A process as recited in claim 1 for fabricating an active optical device.

24. A system for fabricating an optical waveguide comprising:
a support for receiving a piece of material having a substantially planar surface; and
at least one laser for producing a beam for cutting at least two channels in said substantially planar surface of said piece of material so as to define a waveguide therebetween.

25. A system as recited in claim 24, wherein said at least one laser includes two lasers.

26. A system as recited in claim 24, wherein one of said two lasers is a heating laser for heating said substrate at a heating temperature below and near the melting point of said substrate, and the other of said two laser is a writing laser characterized by a writing wavelength which is absorbed by said substrate at said heating temperature for cutting said at least two channels during heating of said substrate; said writing laser being characterized by having a wider laser spot than said heating laser.

27. A system as recited in claim 26, further comprising means for aligning two beams, each produced by one of said heating laser and said writing laser and means for combining both beams produced by said heating and writing lasers, yielding a combined beam, and means for aiming said combined beam towards said substrate.

28. A system as recited in claim 27, wherein said means for aligning two beams includes a mirror.

29. A system as recited in claim 27, wherein said combining means is a beam combiner.

30. A system as recited in claim 27, further comprising a lens for focusing said combined beam onto said substrate.

31. A system as recited in claim 26, wherein said heating laser is a CO₂ laser or a Nd:YAG laser.

32. A system as recited in claim 26, wherein said writing laser is a continuous wave laser.

33. A system as recited in claim 26, wherein said writing laser is selected from a laser type selected from a group consisting of argon, Nd: YLF, semiconductor and Yb doped fibre laser.

34. A system as recited in claim 24, further comprising a beam splitter for splitting said beam in at least two beams for simultaneously cutting said at least two channels in said substantially planar surface of said piece of material.

35. A system as recited in claim 34, wherein said beam splitter is a spatial filter.

36. A system as recited in claim 24, further comprising an optical lens for focusing said beam onto said substantially planar surface of said piece of material.

37. A system as recited in claim 24, wherein said support is a movable table for translating said planar surface of said piece of material relatively to said at least one laser.

38. A system for fabricating an optical waveguide comprising:
means for receiving a piece of material; and
means for cutting at least two channels in said piece of material so as to define a waveguide therebetween.

39. A process for fabricating an optical waveguide comprising:
providing a piece of material having a substantially planar surface;
using at least one laser characterized by a wavelength and a power to cut at least one channel in said substantially planar surface of said piece of material; said dielectric material being substantially absorptive to said wavelength to cause melting of said substrate at said laser power; and
filling said at least one channel with a high refractive index material;
whereby, said at least one channel defining a waveguide.
